(19) United States
(12) Patent Application Publication
(10) Pub. No.: US 2010/0100293 A1
(43) Pub. Date: Apr. 22, 2010

(54) GEAR SHIFT CONTROLLING APPARATUS

(75) Inventor: Yoji Takanami, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, AICHI (JP)

(21) Appl. No.: 12/528,095

(22) PCT Filed: Feb. 28, 2008
(86) PCT No.: PCT/JP08/53562

§ 371 Date: Aug. 21, 2009

(30) Foreign Application Priority Data
Mar. 1, 2007 (JP) 2007-051954

(51) Int. Cl. F16H 63/02; G06F 19/00; F16H 63/00

(52) U.S. Cl. 701/65

(57) ABSTRACT

A gear shift controlling apparatus for changing a gear ratio based on information of a corner, in which the gear ratio is changed by setting a maximum value of a first target gear ratio set based on required deceleration when passing through the corner and a second target gear ratio set based on required driving force obtained from information of a road after exiting the corner, as a target gear ratio. It becomes possible to further improve drivability when driving around the corner.

### TECHNICAL FIELD

The present invention relates to a gear shift controlling apparatus, and particularly relates to a gear shift controlling apparatus capable of further improving drivability when driving around a corner.

### BACKGROUND ART

A gear shift controlling apparatus for changing a gear ratio based on corner information is known. For example, Japanese Patent Application Laid-open No. 2002-122225 (Patent Document 1) discloses a vehicle gear shift controlling apparatus that directly judges a gear shift of an automatic transmission from a down gear shift map stored in advance based on curve information (curvature radius R) of a road and road surface gradient information (road surface gradient θ_{R}), and shifts a gear position so as to perform the judged gear shift, thereby immediately obtaining the gear position or the gear ratio according to the curve of the road and the road surface gradient, in collaborative gear shift control means, when performing collaborative gear shift control of the automatic transmission based on information relating to a condition around a vehicle or in front of the vehicle.
Patent Document 1: Japanese Patent Application Laid-open No. 2002-122225

### DISCLOSURE OF INVENTION

### Problem to be Solved by the Invention

When obtaining a gear ratio to which a current gear ratio is to be changed in the gear shift controlling apparatus, there is a case in which the gear ratio calculated by the degree of the curve (such as a radius R) of the corner, the road surface gradient and the vehicle speed is not an appropriate gear ratio, depending on a road condition after exiting the corner. For example, as shown in FIGS. 8 and 9, there has been a case in which a down gear shift is required when exiting the corner (power-on down, refer to FIG. 9) and in which an unnecessarily low gear is selected when setting the gear ratio when approaching the corner so as to prevent the down gear shift when exiting the corner (refer to FIG. 8), depending on straightness of the road and the road surface gradient after the corners 701 and 702, even when the radius R and the road surface gradient of the corners 701 and 702 are identical.

As described above, there is a case in which a driver feels uncomfortable when trying to obtain an effect of the control, also, when the AT is multistaged or applied to a CVT and a HV, a selection gear ratio becomes larger and it is required to determine the gear ratio with a more detailed condition.

An object of the present invention is to provide the gear shift controlling apparatus capable of further improving drivability when driving around the corner.

### Means for Solving Problem

A gear shift controlling apparatus according to the present invention is a gear shift controlling apparatus for changing a gear ratio based on information of a corner, wherein the gear ratio is changed by setting a maximum value of a first target gear ratio set based on required deceleration when passing through the corner and a second target gear ratio set based on required driving force obtained from information of a road after exiting the corner, as a target gear ratio.

In the gear shift controlling apparatus according to the present invention, at least one of a distance of a straight pathway, a road surface gradient, and a road width is included in the information of the road.

In the gear shift controlling apparatus according to the present invention, the required driving force is obtained based on information of a driver in addition to the information of the road.

### EFFECT OF THE INVENTION

The present invention provides an effect that the drivability can be further improved when driving around the corner.

### BRIEF DESCRIPTION OF DRAWINGS

FIG. 1 is a flowchart illustrating operation of a first embodiment of a gear shift controlling apparatus according to the present invention.

FIG. 2 is a schematic configuration diagram illustrating the first embodiment of the transmission control device according to the present invention.

FIG. 3 is a view for illustrating corner control of the first embodiment of the gear shift controlling apparatus according to the present invention.

FIG. 4 is a view illustrating a gear position corresponding to a vehicle speed and deceleration in the first embodiment of the gear shift controlling apparatus according to the present invention.

FIG. 5 is a view for illustrating a map for calculating a target gear position for getting out of a corner in the first embodiment of the gear shift controlling apparatus according to the present invention.

FIG. 6 is a view for illustrating an effect of the first embodiment of the gear shift controlling apparatus according to the present invention.

FIG. 7 is another view for illustrating the effect in the first embodiment of the gear shift controlling apparatus according to the present invention.

FIG. 8 is a view for illustrating a conventional technology.

FIG. 9 is another view for illustrating the conventional technology.

### EXPLANATIONS OF LETTERS OR NUMERALS

10 automatic transmission
40 engine
90 acceleration sensor
95 navigation system device
114 throttle opening sensor
116 engine rotational number sensor
118 road gradient measuring/estimating unit
122 vehicle speed sensor
123 gear shift position sensor
130 control circuit
131 CPU
133 ROM
701 corner
702 corner
703 third-speed range
704 fourth-speed range
705 fifth-speed range
706 boundary line
707 boundary line
709 boundary line
C corner
L distance to corner
G lateral G
Greqx target deceleration
P current position
Q entrance
R curvature radius of corner
X vehicle

### BEST MODE(S) FOR CARRYING OUT THE INVENTION

Hereinafter, one embodiment of a gear shift controlling apparatus according to the present invention is described.

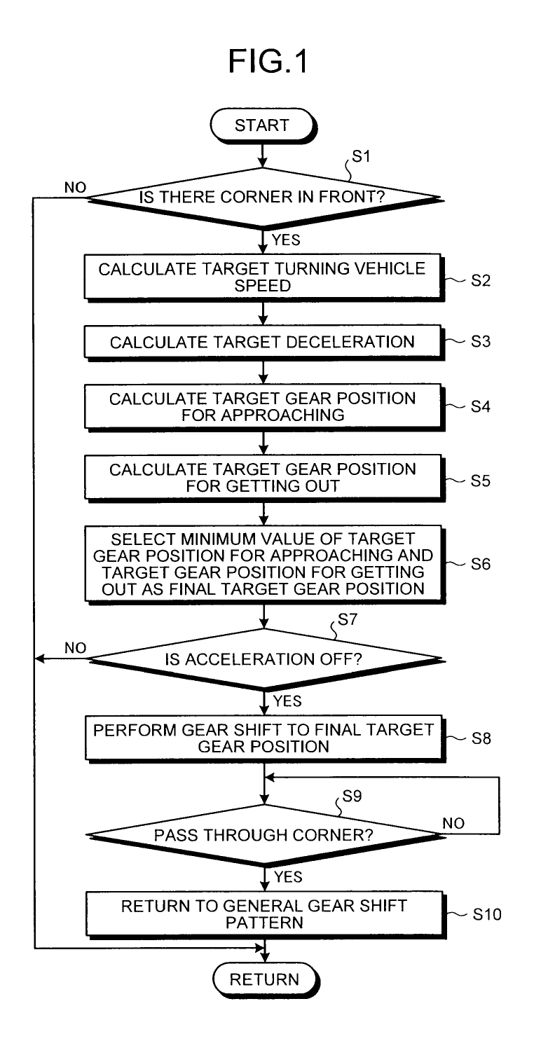

A first embodiment is described with reference to FIGS. 1 to 7.

In the present embodiment, in gear ratio control based on corner information, in addition to control to calculate a target deceleration (required deceleration) based on a degree of a curve of a corner, a road surface gradient and a current vehicle speed, and to calculate an optimal gear ratio (first optimal gear ratio) based on the target deceleration, required driving force is calculated based on a linear distance and the road surface gradient after exiting the corner, the optimal gear ratio (second optimal gear ratio) is calculated based on the required driving force, and a minimum value (low gear ratio) of the above-described first and second optimal gear ratios is selected.

When determining only the first optimal gear ratio for approaching the corner, there is a case in which an appropriate gear ratio is not obtained depending on the linear distance and a road gradient after exiting the corner. Therefore, in the present embodiment, by selecting the minimum value of the same and the second optimal gear ratio based on the required driving force when exiting the corner, setting which meets driver's feeling more than that in a conventional example can be obtained.

As a configuration, the present embodiment is provided with an automatic transmission (such as a stepped automatic transmission, a CVT, and a manual transmission with an automatic gear shift mode), which has means for performing down gear shift control to the corner, and means for detecting or estimating the degree of the curve of the corner (a radius and a curvature of the corner) (such as a navigation system) to be described in detail hereinafter. This is applicable to a hybrid system control device.

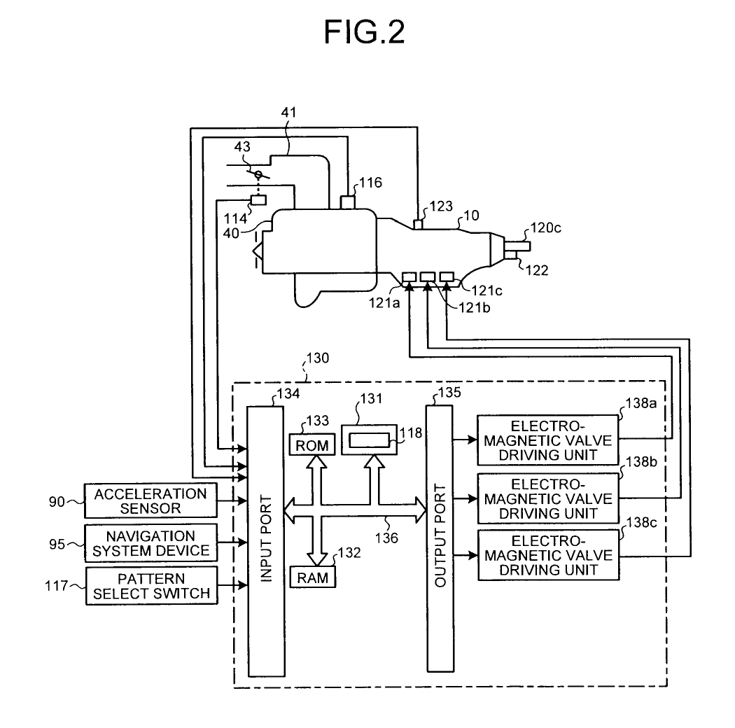

In FIG. 2, reference numerals 10 and 40 represent the stepped automatic transmission and an engine, respectively. The automatic transmission 10 is capable of providing five speeds by controlling hydraulic pressure by energization/non-energization to electromagnetic valves 121a, 121b and 121c. Although the three electromagnetic valves 121a, 121b and 121c are shown in FIG. 2, the number of the electromagnetic valves is not limited to three. The electromagnetic valves 121a, 121b and 121c are driven by signals from a control circuit 130.

A throttle opening sensor 114 detects opening of a throttle valve 43 arranged in an air intake passage 41 of the engine 40. An engine rotational number sensor 116 detects a rotational number of the engine 40. A vehicle speed sensor 122 detects a rotational number of an output axis 120c of the automatic transmission 10, which is in proportion to the vehicle speed. A gear shift position sensor 123 detects a gear shift position. A pattern select switch 117 is used when instructing a gear shift pattern. An acceleration sensor 90 detects the deceleration (decelerative acceleration) of the vehicle.

A fundamental function of a navigation system device 95 is to guide a subject vehicle to a predetermined destination, and is provided with an arithmetic processing device, an information storing medium in which information necessary for driving of the vehicle (such as a map, a straight pathway, a curve, an upslope/downslope and an express way) is stored, a first information detection device including a geomagnetic sensor, a gyrocompass and a steering sensor, for detecting a current position of the subject vehicle and a road condition by self-contained navigation, and a second information detection device including a GPS antenna and a GPS receiver, for detecting the current position of the own vehicle and the road condition by electric navigation.

The control circuit 130 inputs signals indicating detection results of the throttle opening sensor 114, the engine rotational number sensor 116, the vehicle speed sensor 122, the gear shift position sensor 123 and the acceleration sensor 90, inputs the signal indicating a switching condition of the pattern select switch 117, and inputs the signal from the navigation system device 95.

The control circuit 130 is composed of a well-known microcomputer, and is provided with a CPU 131, a RAM 132, a ROM 133, an input port 134, an output port 135 and a common bus 136. The signals from the above-described sensors 114, 116, 122, 123 and 90, the signal from the above-described switch 117, and the signal from the navigation system device 95 are input to the input port 134. Electromagnetic valve driving units 138a, 138b and 138c are connected to the output port 135.

A road gradient measuring/estimating unit 118 may be provided as a part of the CPU 131. The road gradient measuring/estimating unit 118 may be a unit for measuring or estimating the road gradient based on the acceleration detected by the acceleration sensor 90. Also, the road gradient measuring/estimating unit 118 may be a unit for storing the acceleration on a flat road in the ROM 133 in advance and comparing the same with the acceleration actually detected by the acceleration sensor 90 to obtain the road gradient.

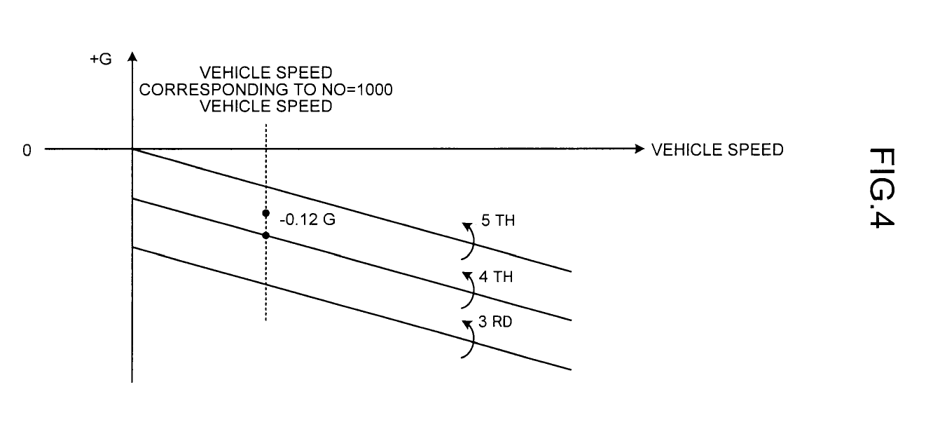

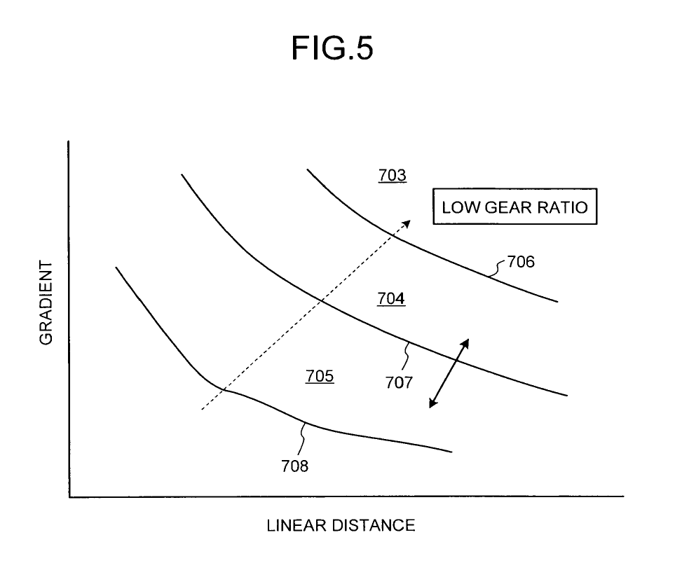

A program in which operation (control step) shown in a flowchart in FIG. 1 is described in advance, maps shown in FIGS. 4 and 5, and a program in which operation of the gear shift control (not shown) is described are stored in the ROM 133. The control circuit 130 performs a gear shift of the automatic transmission 10 based on various control conditions, which are input.

The operation of the present embodiment is described with reference to FIGS. 1 to 3.

The radius and the curvature of the corner are considered to be information indicating the degree (size) of the curve of the corner. Hereinafter, in a portion described by using a radius R of the corner, the curvature of the corner may be used in place of the radius R of the corner.

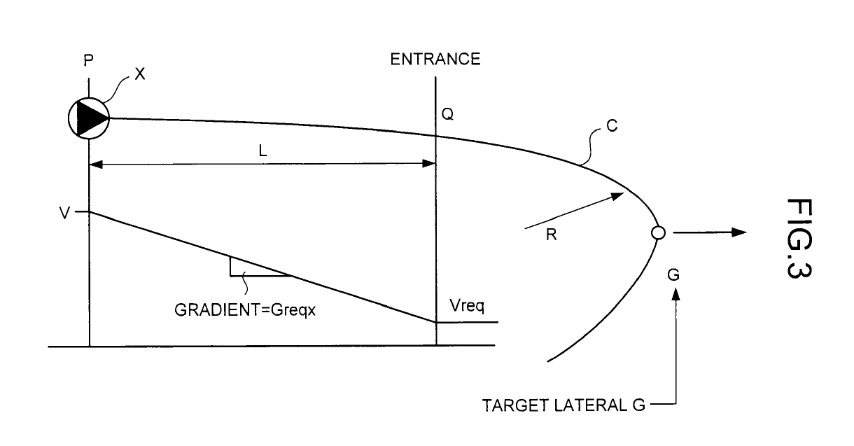

FIG. 3 is a view for illustrating the target deceleration (required deceleration) when approaching the corner. In FIG. 3, reference numerals X, P and C represent the vehicle, the current position of the vehicle X, and the corner in front of the vehicle X, respectively. Also, reference numerals Q, R, L, V, Vreq and Greqx represent an entrance of the corner C, a curvature radius of the corner C, a distance between the current position P of the vehicle X and the entrance Q of the corner C, a current vehicle speed of the vehicle X, a target turning vehicle speed for turning the corner C with target lateral G (target lateral acceleration), and deceleration required in order that the vehicle X of which current vehicle speed is V reaches the target turning vehicle speed Vreq at the entrance Q of the corner C (target deceleration, which should act on the vehicle, in the corner control), respectively. In the above-description, the target lateral G is a target value indicating a degree of the lateral G, with which the vehicle should turn the corner C, and is the value from 0.3 to 0.4 G set in advance, for example.

[Step S1]

At a step S1 shown in FIG. 1, the control circuit 130 judges whether there is a corner in front. The control circuit 130 performs the judgment at the step S1 based on the signal input from the navigation system device 95. As a result of the judgment at the step S1, when it is judged that there is a corner in front, the procedure shifts to a step S2, and if this is not the case, this control flow is terminated. Since there is the corner C in front of the vehicle X in an example shown in FIG. 3, the procedure shifts to the step S2.

[Step S2]

At the step S2, the control circuit 130 calculates the target turning vehicle speed Vreq at the corner C. At the time of the calculation, the control circuit 130 first calculates the curvature radius R of the corner C based on map information of the navigation system device 95. Next, the control circuit 130 obtains the distance L from the current position P to the entrance Q of the corner C and the current vehicle speed V, based on the signal input from the navigation system device 95. Then, the control circuit 130 obtains the vehicle speed (target turning vehicle speed Vreq) at the entrance Q of the corner C based on the target lateral G set in advance and the curvature radius R of the corner C. The control circuit 130 obtains the target turning vehicle speed Vreq [m/s] from the following equation [equation 1]. After the step S2, a step S3 is carried out.

[equation 1]

Vreq=\sqrt{R×Gyt×g} (1)

where,
R: corner R[m]
Gyt: target lateral G appropriate value (such as 0.4 G)
g: gravity acceleration 9.8 [m/s²]

[Step S3]

At the step S3, the control circuit 130 calculates the target deceleration (required deceleration). The control circuit 130 obtains the target deceleration based on the distance L between the current position P and the entrance Q of the corner C, the vehicle speed V at the current position P, and the target turning vehicle speed Vreq at the Q point. The target deceleration Greqx is obtained by the following equation 2. After the step S3, a step S4 is carried out.

$$\begin{matrix}[ equation 2 ] & \\ Greqx = \frac{{V}^{2} - {Vreq}^{2}}{2 \times L \times g} & ( 2 )\end{matrix}$$

where
V: current vehicle speed [m/s]
L: distance from the vehicle to the corner entrance [m]

[Step S4]

At the step S4, the control circuit 130 obtains a gear position (target gear position for approaching the corner), which should be selected at the time of the gear shift control when approaching the corner, based on the target deceleration obtained at the above-described step S3. Data of vehicle characteristics indicating deceleration G of each vehicle speed of each gear position at the time of acceleration OFF, as shown in FIG. 4, is registered in advance in the ROM 133.

Here, assuming a case in which an output rotational number is 1000 [rpm] and the target deceleration is −0.12 G, in FIG. 4, it is known that the gear position corresponding to the vehicle speed when the output rotational number is 1000 [rpm] and of which deceleration is the closest to −0.12 G, which is the target deceleration, is fourth-speed. Thereby, it is determined that the target gear position for approaching the corner is the fourth-speed in a case of the above-described example.

Meanwhile, although the gear position with which the deceleration is the closest to the target deceleration is here selected as the target gear position for approaching the corner, the gear position with which the deceleration is the closest to the target deceleration and is not larger (or not smaller) than the target deceleration may be selected as the target gear position for approaching the corner. Also, although the target gear position for approaching the corner is obtained by comparing an engine brake of each gear position and the target deceleration in the above-description, this may be obtained based on the map (not shown) set in advance with which the target gear position for approaching the corner is obtained according to the target deceleration, for example, in place of this method of obtaining. After the step S4, the procedure shifts to a step S5.

[Step S5]

At the step S5, the control circuit 130 obtains the gear position, which should be selected at the time of the gear shift control when getting out of (exiting) the corner (target gear position for getting out of the corner). In this case, the target gear position for getting out of the corner can be obtained by the following method.

The target gear position for getting out of the corner can be obtained by the following method (1) or (2) based on the distance of the straight pathway and the road surface gradient after exiting the corner, which are input from the navigation system device 95.

(1) First, the target vehicle speed set in advance for each distance of the above-described straight pathway is obtained. The longer the distance of the straight pathway, the higher value the target vehicle speed is set. Next, a target time to reach the target vehicle speed is set. Here, the target time may be a fixed value set in advance. Next, the required driving force to achieve the target vehicle speed with the target time is calculated. Then, a gear ratio, which satisfies a sum of the required driving force and allowance set in advance, can be obtained as the target gear position for getting out of the corner.

(2) The gear ratio can be obtained as the target gear position for getting out of the corner based on the distance of the above-described straight pathway and the road surface gradient, by setting the map as shown in FIG. 5 in advance. In the map shown in FIG. 5, for example, ranges represented by reference numerals 703, 704 and 705 indicate third-speed, forth-speed, and fifth-speed, respectively. The longer the distance of the straight pathway, or the larger the road surface gradient, the lower gear side the target gear position for getting out of the corner is set.

Boundary lines 706 to 708 of the above-described ranges 703 to 705 may be changed by the current vehicle speed. By changing the boundary lines 706 to 708 to be located on an upper right portion of the map as the current vehicle speed is higher, it is possible to set the target gear position for getting out of the corner so as to tend to be lower as the vehicle speed is lower. The lower the current vehicle speed is, the more quickly it should be accelerated to reach the target vehicle speed within the target time, so that it can be set such that the lower the vehicle speed is, the lower the gear is.

In the above-described method (1), the target gear position for getting out of the corner may be obtained based on the required acceleration in place of the required driving force, and the road surface gradient can be used for calculating the required acceleration. Also, the target gear position for getting out of the corner can be set depending on a width of the road and driving orientation, in addition to or in place of the distance of the above-described straight pathway and/or the road surface gradient. The larger the width of the road is, the higher the target vehicle speed (the vehicle speed, which the driver thinks appropriate) can be set. The target vehicle speed can be changed depending on the driving orientation and a past driving history.

Also, in the above description, the distance of the above-described straight pathway is substantially judged, and when there is a signal light or the like on the straight pathway, it is judged that the straight pathway continues to a point of the signal light or the like. Meanwhile, as an index to determine the target vehicle speed, the degree of the curve of the corner can be used in place of the distance of the straight pathway.

In this example, the target gear position for getting out of the corner is set to be the third-speed. After the step S5, the procedure shifts to a step S6.

[Step S6]

At the step S6, the control circuit 130 selects the minimum value (low gear side) of the target gear position for approaching the corner obtained at the above-described step S4 and the target gear position for getting out of the corner obtained at the above-described step S5 as a final target gear position. In the above-described example, the third-speed, which is the minimum value of the target gear position for approaching the corner (fourth-speed) and the target gear position for getting out of the corner (third-speed), is selected as the final target gear position. After the step S6, the procedure shifts to a step S7.

[Step S7]

At the step S7, the control circuit 130 judges whether an idle contact is ON. In this example, it is judged that the driver intends to decelerate when the idle contact is ON (accelerator opening is completely closed). At the step S7, it is judged whether the accelerator is in an OFF-state (completely closed) based on the signal from the throttle opening sensor 114. As a result of the step S7, when it is judged that the accelerator is in the OFF-state, the procedure shifts to a step S8. On the other hand, when it is not judged that the accelerator is in the OFF-state, this control flow is returned.

[Step S8]

At the step S8, the control circuit 130 outputs a gear shift command according to the final target gear position selected at the above-described step S6 (third-speed in the above-described example). That is to say, a down gear shift command (gear shift command) is output from the CPU 131 of the control circuit 130 to the electromagnetic valve driving units 138a to 138c. In response to the down gear shift command, the electromagnetic valve driving units 138a to 138c put the electromagnetic valves 121a to 121c in an energizing or a non-energizing state. This allows the automatic transmission 10 to carry out the gear shift to the final target gear position instructed by the down gear shift command. Due to the down gear shift to the final target gear position, engine brake force (deceleration) increases and the vehicle speed decreases. After the step S8, a step S9 is carried out.

[Step S9]

At the step S9, the control circuit 130 judges whether the vehicle passes through the corner. The control circuit 130 can perform the judgment at the step S9 based on the information from the navigation system device 95. As a result of this judgment, when it is judged that the vehicle has passed through the corner, the procedure shifts to a step S10, and if this is not the case, the procedure returns back to the step S9.

[Step S10]

At the step S10, the control circuit 130 allows the gear shift control to return to the gear shift based on a general gear shift pattern. Here, the general gear shift pattern is based on a general gear shift map in which the gear position is determined based on the accelerator opening and the vehicle speed. After the step S10, this control flows is returned.

According to the present embodiment, the following effect can be obtained.

In the present embodiment, the gear ratio is changed by setting a maximum value (low gear side) of the first target gear ratio set based on the required deceleration when passing through the corner and the second target gear ratio set based on the road information (such as the road surface gradient and the linear distance) after exiting the corner as the target gear ratio, in the gear shift controlling apparatus for changing the gear ratio based on the corner information. This improves drivability.

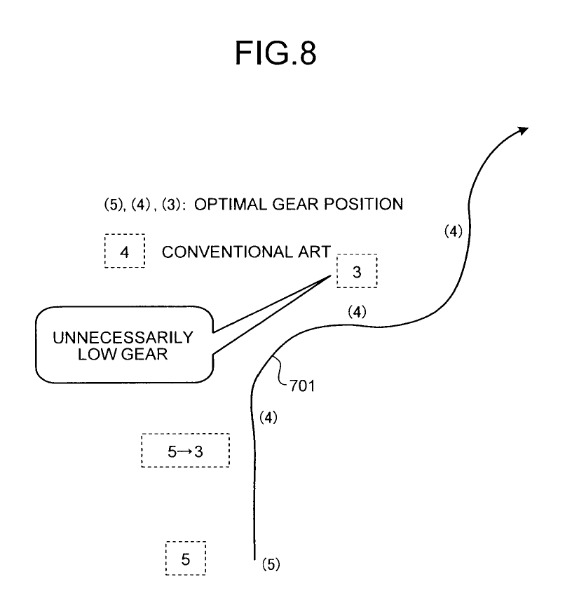

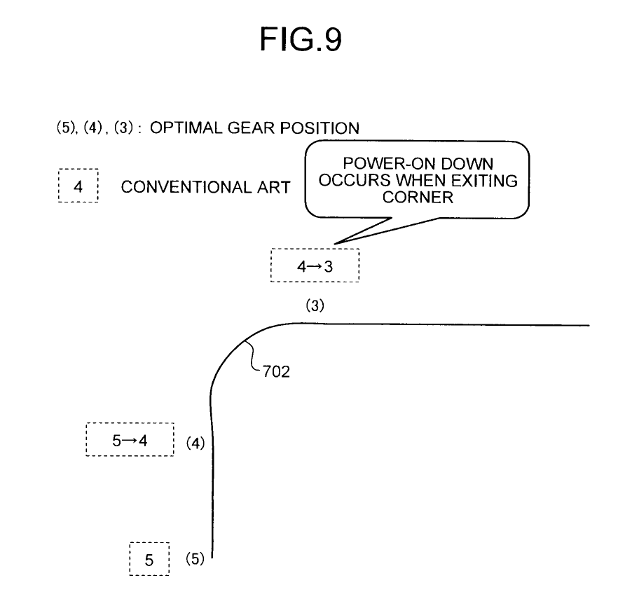

According to the conventional technology, as shown in FIGS. 8 and 9, there has been a case in which the down gear shift is required when exiting the corner (power-on down, refer to FIG. 9), and in which unnecessarily low gear is selected when setting the gear ratio when approaching the corner so as to prevent the down gear shift when exiting the corner (refer to FIG. 8), depending on straightness of the road and the road surface gradient after the corners 701 and 702, even when the radius R and the road surface gradient of the corners 701 and 702 are identical.

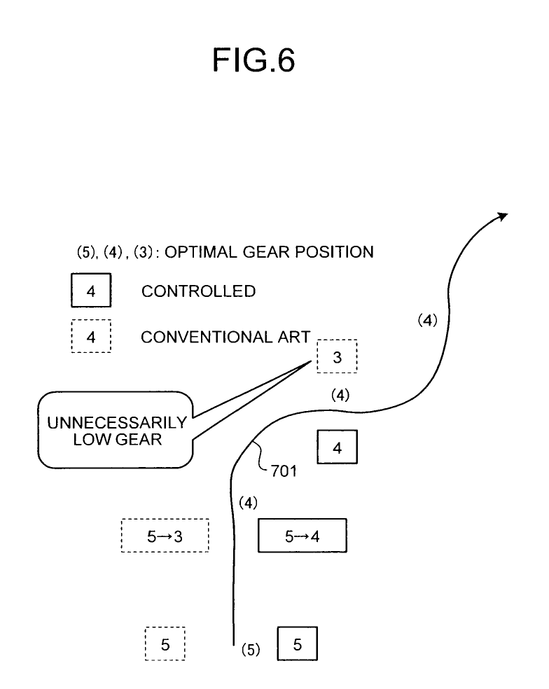

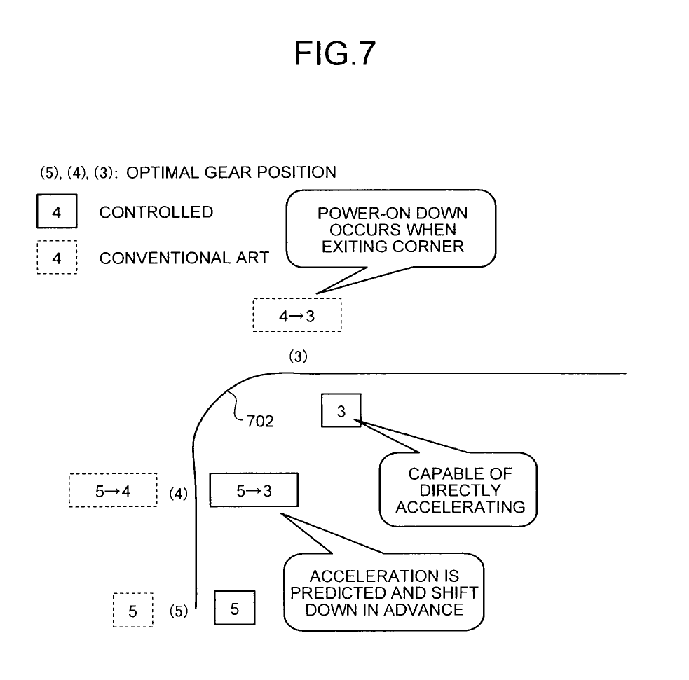

On the other hand, according to the present embodiment, it is controlled by obtaining two kinds of target gear positions, which are the target gear position for approaching the corner and the target gear position for getting out of the corner, and by setting the minimum value (low gear side) of them as the final target gear position. Therefore, as shown in FIGS. 6 and 7, even when the radius R and the road surface gradient of the corners 701 and 702 are identical, the target gear position for getting out of the corner of the corner 701 is set to the fourth-speed and the target gear position for getting out of the corner of the corner 702 is set to the third-speed, depending on the straightness of the road and the road surface gradient after the corners 701 and 702.

Thereby, even when both of the target gear positions for approaching the corner of the corners 701 and 702 are fourth-speed, the minimum value of the target gear position for approaching the corner and the target gear position for getting out of the corner of the corners 701 and 702 are fourth-speed and the third-speed, respectively. At the corner 701, the unnecessarily low gear is prevented. At the corner 702, the acceleration after exiting the corner is predicted, so that the gear is shifted down to the third-speed in advance before approaching the corner and it is possible to directly accelerate after exiting the corner. Meanwhile, numbers in parentheses in FIGS. 6 to 9 represent the optimal gear positions.

Also, as the transmission in the above-described embodiment, the CVT and the HV can be applied. Also, although the deceleration indicating an amount to be decelerated by the vehicle has been described by using the negative acceleration (G) in the above-description, this can also be controlled based on reduction torque.

### INDUSTRIAL APPLICABILITY

As described above, the gear shift controlling apparatus according to the present invention is useful as the gear shift controlling apparatus capable of further improving the drivability when driving around the corner, and particularly suitable for further improving the drivability when driving around the corner.

1. A gear shift controlling apparatus for changing a gear ratio based on information of a corner, comprising:
a transmission; and
a controlling unit that calculates a required deceleration when passing through the corner, sets a first target gear ratio based on the calculated required deceleration, calculates a required driving force from information of a road after exiting the corner, and sets a second target gear ratio based on the calculated required driving force, wherein
the controlling unit changes the gear ratio of the transmission by setting a maximum value of the first target gear ratio and the second target gear ratio as a target gear ratio.

2. The gear shift controlling apparatus according to claim 1, wherein
at least one of a distance of a straight pathway, a road surface gradient, and a road width is included in the information of the road.

3. The gear shift controlling apparatus according to claim 1, wherein
the required driving force is obtained based on information of a driver in addition to the information of the road.

4. The gear shift controlling apparatus according to claim 2, wherein
the required driving force is obtained based on information of a driver in addition to the information of the road.

5. A gear shift controlling method for changing a gear ratio based on information of a corner, comprising:
calculating a required deceleration when passing through the corner;
setting a first target gear ratio based on the calculated required deceleration;
calculating a required driving force from information of a road after exiting the corner;
setting a second target gear ratio based on the calculated required driving force; and
changing the gear ratio of the transmission by setting a maximum value of the first target gear ratio and the second target gear ratio as a target gear ratio.

6. The gear shift controlling method according to claim 5, wherein
at least one of a distance of a straight pathway, a road surface gradient, and a road width is included in the information of the road.

7. The gear shift controlling method according to claim 5, wherein
the required driving force is obtained based on information of a driver in addition to the information of the road.

8. The gear shift controlling method according to claim 6, wherein
the required driving force is obtained based on information of a driver in addition to the information of the road.
